(19) United States
(12) Patent Application Publication
(10) Pub. No.: US 2012/0327406 A1
(43) Pub. Date: Dec. 27, 2012

(54) APPARATUS AND METHOD FOR CHARACTERIZING AN ELECTROMAGNETIC SIGNAL USING SPECTRAL ANALYSIS

(75) Inventors: Jan J. Dubowski, Sherbrooke (CA); Dominic Lepage, Saint-Denis-de-Brompton (CA); Sebastien Blais-Ouelette, Laval (CA)

(73) Assignee: SOCPRA SCIENCES ET GENIE S. E. C., Sherbrooke, QC (CA)

(21) Appl. No.: 13/575,146

(22) PCT Filed: Jan. 27, 2011
(86) PCT No.: PCT/CA2011/050047

§ 371 Date: Sep. 11, 2012

Related U.S. Application Data
(60) Provisional application No. 61/298,807, filed on Jan. 27, 2010.
(60) Provisional application No. 61/435,770, filed on Jan. 24, 2011.

(51) Int. Cl. G01J 3/42; G01J 3/28

(52) U.S. Cl. 356/300

(57) ABSTRACT

An apparatus for characterizing energy and direction dependence of intensity for an electromagnetic signal uses spectral analysis and has particular application in the field of surface plasmon resonance. An energy dependent filter is located in an imaging space of the signal and separates the signal in an energy dependent manner. A first portion of the signal output from the filter is limited to a predetermined range of narrow energy bands and is directed to a photodetector. The photodetector receives the first signal portion and detects signal intensities across the photodetector surface, each of the signal intensities corresponding to a specific wavevector direction and energy band within the predetermined range. The filter provides said energy dependent selection for each of a plurality of different ranges of energy bands so as to create a three-dimensional dataset indicative of the energy and direction dependence of the signal intensity.

### BACKGROUND OF THE INVENTION

The fundamental properties of any electromagnetic (EM) radiation, or light, can be described by its dispersion relation. The dispersion properties state the intrinsic relationship between the light's energy (E), its speed and direction of propagation (i.e. the radiation's wavevector k). The measurement of any or all these variables, along with the radiative flux intensity (I), is used to describe the EM-waves in technological applications, especially in scenarios where the waves are employed to probe media of various kinds.

A specific example where the dispersion relation is directly measured can be found in the field of surface plasmon resonance (SPR) for biochemical sensing. The SPR phenomenon occurs when an incoming EM radiation induces a coherent charge fluctuation at a metal-dielectric interface. The resulting coupled surface plasmon (SP) wave is strongly bounded to the interface and can be employed to probe refractive indices within a few 100-200 nm from the metal surface. This is conventionally accomplished by probing the intensity dependent dispersion relation I(E,k) of the charge coupled electromagnetic SPs, under a predetermined condition of resonance in either energy E (fixed incident energy) or in wavevector k (fixed incident coupling angle). Time-resolvable biochemical adsorption events can then be monitored for that resonance energy or wavevector. Tracking the SPR for all the E and k would generate a multi-dimensional surface providing invaluable information on the surficial events at the interface, but the full characterization of EM-waves has so far been impractical because of the difficulty to separate these variables and collect the volume of data that would consequently be generated.

### SUMMARY OF THE INVENTION

A more global approach taken by the present invention directly monitors the general dispersion relation of an electromagnetic signal received from an object, providing a complete characterization of the signal's fundamental properties, namely intensity (I), energy (E) and wavevectors (k). The specific cause of the electromagnetic signal may vary from one application to another, including situations where it has been emitted, reflected, diffracted, scattered, diffused, or produced by non-linear electromagnetic phenomena. The complete mapping of the dispersion relation of EM signals presents great technological advantages in a variety of different fields, especially in scenarios where the waves are employed to probe media of various kinds, such as those making use of SPR. In the specific case of SPs, their resonance occurs in a particular plane in the three-dimensional (3D) space of the intensity distribution of the E(k) dispersion. Nonetheless, the measurement of the complete dispersion relation is a difficult experiment because of the fundamental intertwinement of the variables involved. Consequently, the full characterization of EM-waves has so far been impractical because of the difficulty in separating these variables and collecting the volume of data that would thus be generated.

In accordance with the present invention, an apparatus is provided for characterizing energy and direction dependence of intensity for an electromagnetic signal received from a source. An energy dependent filter, such as a volume Bragg grating, is located in an imaging space of the signal. That is, the filter is located in a region where the signal is converging or diverging, and where the wavevector directions of the electromagnetic signal have a one-to-one correspondence to wavevector directions of the electromagnetic signal from the source. The filter separates the signal in an energy dependent manner such that a first portion of a signal output from the filter is directed to an output location and is limited to signal energy in a predetermined range of narrow energy bands (the use of the term “energy band” herein refers to a narrow range of energy values isolated by the filter, and should not be confused with the term “energy band” as used in the field of atomic physics). In an exemplary embodiment, the filter is also tunable so as to change this predetermined energy band range, although the use of multiple fixed filters, with or without tunable filters, is also possible. A photodetector is located at the output location and receives the first signal portion. The photodetector detects signal intensities at a plurality of locations within a cross section of the first signal portion, and each of the signal intensities corresponds to a specific direction and energy band within the predetermined range. In the exemplary embodiment, as the tuning of the filter is changed, the energy band corresponding to each of the detected signal intensities also changes.

The system according to the invention allows the construction of a three-dimensional data set relative to the detected signal intensities. Each of the intensities in the signal cross-section corresponds to a wavevector direction of the electromagnetic signal, and each of these intensities is measured for each of the selected energy band ranges. In this way, a complete characterization may be found for the electromagnetic signal that indicates the directional and energy dependence of signal intensity. The system lends itself to a variety of different applications although, in an exemplary embodiment, the electromagnetic signal is received from a surface as a result of the diffraction of a surface plasmon resonance.

Different system components may be used advantageously with the invention, depending on the particular application and arrangement. For example, the signal may originate as divergent electromagnetic energy from a source, and collection optics may be used to collect and focus the electromagnetic signal. Such collection optics may take a variety of different forms, and may include a microscope objective or a component for focusing the electromagnetic energy, such as a lens or a mirror. As mentioned above, a volume Bragg grating is used as the energy selective filter in an exemplary embodiment of the invention, but other filtering devices may be used as well. In one particular embodiment, the filter is located at a focal plane of the electromagnetic signal, that being a point of minimum cross-section of the signal within the imaging space. In the exemplary embodiment, the photodetector comprises a two-dimensional photodetector array and is located at a pupil plane of the electromagnetic signal, such that all of the signal energy having the same departure angle from the source is incident at the same point on the photodetector.

### BRIEF DESCRIPTION OF THE DRAWINGS

FIG. 1 is a schematic view of the inducing of a surface plasmon resonance phenomenon.

FIG. 2 is a schematic view of an exemplary embodiment of the invention.

FIG. 3 is a schematic view of the organization of a three-dimensional dataset resulting from an analysis using the embodiment of FIG. 2.

FIG. 4 is a schematic view of a surface plasmon resonance structure having an embedded photo-emitting layer.

FIG. 5 is a schematic view of a structure such as that shown in FIG. 4 being used in conjunction with the present invention.

### DETAILED DESCRIPTION

The present invention is directed to an analysis instrument for mapping and characterizing an electromagnetic dispersion relation phenomenon without limitation of the energy and wavevector variables. An example of the use of such an instrument is in conjunction with an SPR system. While conventional SPR limits the input variables of the system (and therefore the output data) to simplify the measurement process, the present invention has no such limitations, and collects a more complete dataset indicative of intensity relative to angular wavevector direction for each of a wide range of energies. Although the use of the invention is not limited to SPR applications, an SPR embodiment is illustrative, and is described in more detail below.

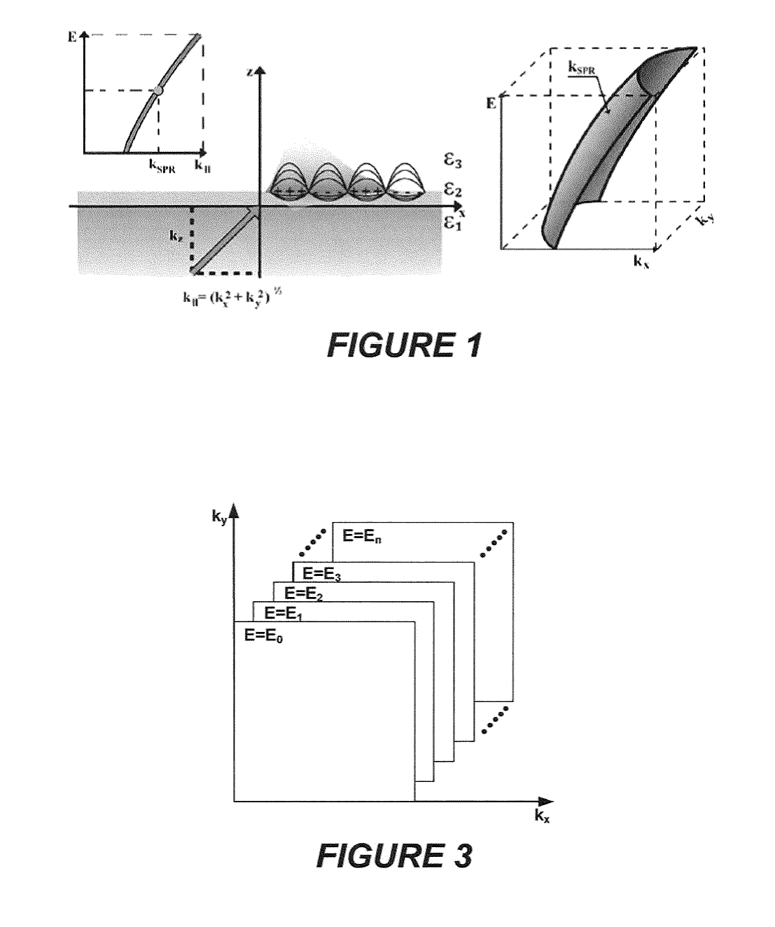

An SPR event takes place in the three-dimensional space of the intensity distribution of the dispersion E(k). It can be induced optically by means of an EM wave directed toward a metal-dielectric interface. At a given energy E, the resonance is achieved when the projected in-plane wavevector of the incoming EM wave has a wavevector of norm k_{II}²=kₓ²+k_{y}²=k_{SPR}². However, this condition can be met for a number of different energies and values of k_{SPR}, following an SPR dispersion relation E(kₓ, k_{y}), distributed in 3D Fourier space described by the quantities E, kₓ and k_{y}, as depicted in FIG. 1. Time-dependent changes at the SPR surface, as reflected in changes to the surface refractive index, may be monitored to track events, such as biochemical changes, occurring within the evanescent EM fields of the surface plasmons.

In order to limit the variables to be monitored, conventional SPR systems use an input light source having either a fixed energy E or a fixed incident angle. The events occurring on the surface can then be monitored relative to the fixed input variable. However, this necessarily limits the amount of information that may be gathered by the SPR system, which is capable of detecting only anticipated changes within the fixed parameter limits. Other information that might be gathered by using an input signal at a different energy, or at a different angle of incidence, is excluded.

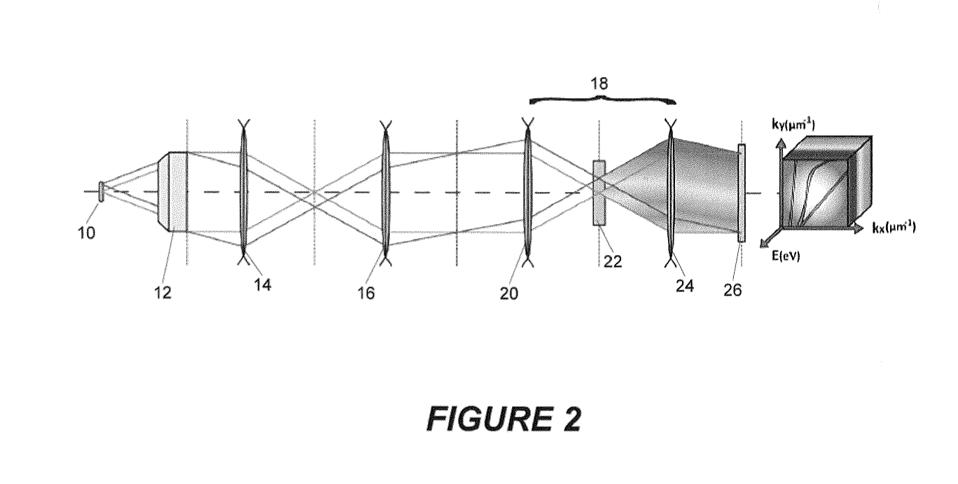

The more global approach of the present invention, in effect, directly monitors the general dispersion relation of any light received from an object of interest, providing a complete map in I(E,k) under specific conditions, thereby describing the entire system state. A first embodiment of the invention is shown in FIG. 2, for which a hyperspectral analysis technique is used to measure the dispersion relation properties for a wide range of energies and wavevector directions.

Broadband light from a surface 10 of interest is collected over a field of view and collimated by a microscope objective 12. Light of this type may result from the illumination of an SPR surface with a broadband source, with no limitation on the input angle. On particular example of a device capable generating such emissions may be found in U.S. patent application Ser. No. 12/015,725, the substance of which is incorporated herein by reference. In this example, a single structure includes both an SPR detection surface and an integrated photo-emitting substrate layer. With the emission of unrestricted broadband light from the substrate layer, an SPR effect is produced at the surface at a wide range of energies and wavevector directions.

In the embodiment of FIG. 2, the light from microscope objective 12 is focused by lens 14 and recollimated by lens 16. The recollimated beam is then directed to a first lens 20 of a hyperspectral analyzer 18. The use of three lenses (14, 16, 20) is optional, and allows for elongation of the system to simplify the design process. This section may also be desirable for other reasons, such as to allow the introduction of other optical elements, such as beam splitters for multiple characterization of the signal, filters to cut out some undesired signal from entering the analyzer or some other lenses for correcting aberrations in the signal. In addition, those skilled in the art will recognize that the lens 14 may also function as a first component of the hyperspectral analyzer 18, if the lenses 16 and 20 were omitted. Moreover, focusing of the signal may be accomplished using lenses, mirrors or any other element that can shift an image plane into a pupil plane.

The hyperspectral analyzer uses a energy sensitive element that, in the present embodiment, is a volume Bragg grating (VBG) 22 that filters incoming light according to energy and angle of incidence on the grating. Notably, the VBG 22 is located in an imaging space for the signal. That is, it is located in a region where the electromagnetic signal is in a state of convergence (positive convergence or negative convergence, i.e., divergence), where the convergence angles have a one-to-one correspondence to the departure angles within the electromagnetic signal received from the surface 10. The location of the VBG 22 in an imaging region results in the filtering of the signal being correlated to the wavevector directions of the signal energy, which is of significant interest in SPR and other fields. The convergent lens 20 establishes the imaging space within which the VBG 22 is located and, in the exemplary embodiment, the VBG 22 is located at a focal plane. While this is not critical to the invention, it is advantageous in that the cross sectional area of the signal is at its smallest at the focal plane.

The signal filtered by the VBG 22 is collected by a collimating lens 24 and directed toward a two-dimensional photodetector 26, such as a charge coupled device (CCD) camera, which is located at a pupil plane of the system and which detects the intensity at each of an array of photosensitive pixels (the use of the term “pupil plane” herein refers to a plane in which all of the signal energy having the same departure angle from the source is incident at the same point). Because of the difference in angle of incidence of different portions of the EM signal arriving at the VBG 22 relative to the grating direction, the intensities collected by the photodetector 26 at one grating position represent a gradient of energies across one of the two dimensions of the photodetector surface. Nevertheless, each pixel corresponds to one wavevector direction, and the VBG 22 may be rotated to change the selected energy band, thereby shifting the range of energies being collected at each grating position. By collecting data at each of many different grating positions, a dataset may be assembled that corresponds to intensity measurements for each wavevector at a wide range of different energies. This allows for a measurement of intensity for all of the SPR energies of interest relative to the specific wavevector directions for a given analysis.

A fundamental principle of the system shown in FIG. 2 is the collection of a dataset that correlates intensity to energy and angle for the light received from object 10. An SPR system such as that discussed above is an example of where such a correlation is of particular value, although other possible applications exist. Because the departure angle of the light from the object is of particular importance in an SPR system, the VBG 22 of hyperspectral analyzer 18 is located in a region of focused light from the object 10. Thus, the intensity of the electromagnetic energy passing from the VBG 22 to the photodetector 26 may be measured according to its directional characteristics, as well as for the energy band selected by the VBG 22 for the given angle of incidence. Light at the same angle that is outside of the selected band has a different degree of refraction due to the grating, and is not incident on the same point on the photodetector 26. With correct positioning of the photodetector (and other system components), each captured dataset therefore consists of a two dimensional array of intensities, each of which corresponds to a different wavevector direction of light received from the surface 10 for a given energy band. As the VBG 22 is rotated, the energy band selected for each wavevector direction is changed, and a new set of intensities is captured for the same wavevectors. Since the VBG 22 is rotated in just one angular direction, the change in selected energy band is common along one of the two dimensions of the photodetector, and a continuous energy “gradient” is thus formed along the perpendicular dimension for each set of the two-dimensional intensity datasets collected. All of the collected datasets together form a hyperspectral “cube,” which may thereafter be used to characterize a full range of broadband light relative to energy and wavevector direction.

FIG. 3 is a schematic depiction of a hyperspectral cube collected by the system of FIG. 2. As shown, for each of the energy bands, a two-dimensional array of intensities is collected, the intensities each being representative of the intensity of light collected along a particular wavevector (kₓ,k_{y}). Thus, the entire three-dimensional dataset may be characterized in terms of intensity as a function of energy and wavevector, or I(E,kₓ,k_{y}). In FIG. 3, the different intensity mappings are shown for a continuum of energies identified by energy E, ranging from E₀ to Eₙ.

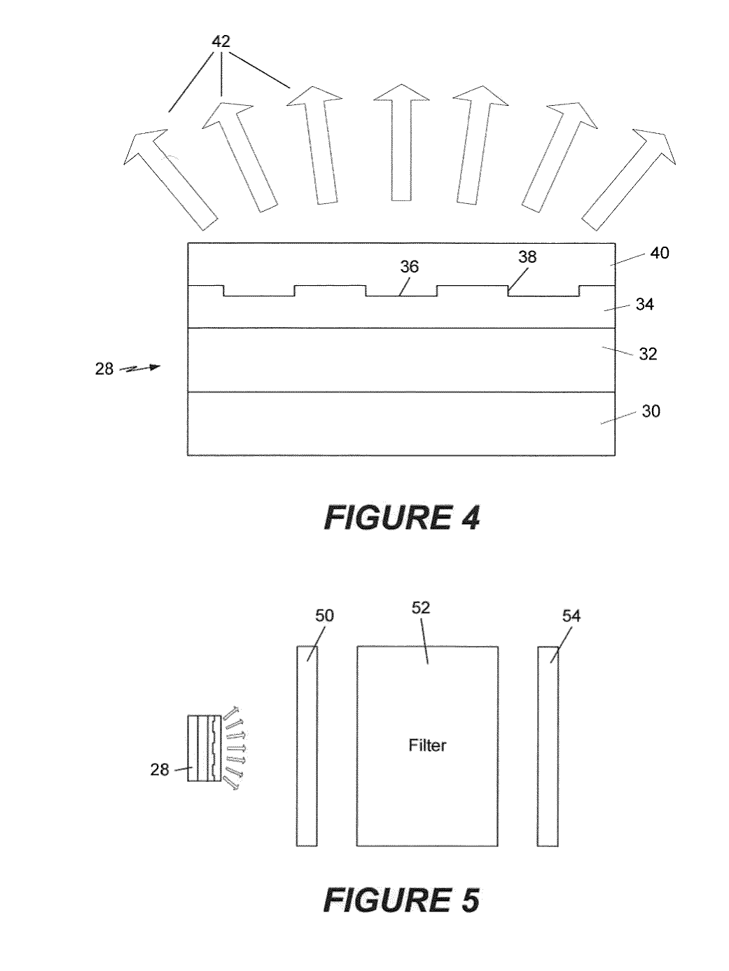

The present invention allows for the characterization of the electromagnetic energy emissions from a surface in terms of energy and wavevector direction. An analysis of this type might be conducted on emissions from an SPR structure such as that shown in the aforementioned U.S. patent application Ser. No. 12/015,725. This structure is described in more detail in conjunction with FIG. 4.

The SPR structure 28 of FIG. 4 uses a photo-emitting substrate layer 30 to generate a luminescence signal. This layer may be, for example, a GaAs—AlGaAs heterostructure, or any of a number of other photo-emitting materials. A laser may be used to excite the substrate layer, or an electroluminescence signal may be generated through electrical biasing of the layer, which allows substantial miniaturizing and simplifying of the structure. Adjacent to the photo-emitting layer 30 is a dielectric adaptive layer 32, which may be SiO₂, or some other material having a refractive index greater than the index of the substance to be characterized. The nature of this refractive index will influence the surface plasmon resonance modes.

A sensing layer 34 adjacent to the dielectric adaptive layer is typically made of a metal such as gold. Any interface between two or three materials able to support surface plasmons will only do so for specific frequencies. The supported frequencies are modulated by the nature of the materials and the geometries involved. In the present example, the gold sensing layer supports surface plasmons of 1.51 eV, and energy corresponding to the light emission of the photo-emitting substrate 30. Other metals, such as silver or aluminum, should be used in combination with other photo-emitting substrate materials.

The sensing outer surface 36 of the structure is opposite the dielectric adaptive layer 32 and is geometrically functionalized, for example, with a linear grating pattern 38. This induces surface plasmon resonance in response to the luminescence signal from the photo-emitting substrate layer 30, and extracts the surface bounded modes of resonance of the surface plasmons at the interface between the sensing layer 34 and the substance 40 to be characterized.

The presence of the substance 40 to be characterized influences the electromagnetic signal 42 received from the structure. Because the luminescence signal from the photo-emitting layer 30 is not limited in energy or wavevector direction, the EM signal 42 has many directions and energies. Thus, for characterizing the substance 40 using an unrestricted SPR analysis, the hyperspectral analyzing technique of the present invention is particularly effective. An arrangement for doing such a characterization is shown in FIG. 5.

A structure 28 like that of FIG. 4 is shown in FIG. 5 outputting EM energy resulting from an SPR effect. This EM signal is collected by collection optics 50, which may be a combination of lenses like those shown in the embodiment of FIG. 2. The collected signal is then passed through an energy selective filter 52, which selects a limited range of narrow energy bands in the signal, the EM energy in those bands being directed toward photodetector 54. The combination of collection optics 50, filter 52 and photodetector 54 make up the general components of an analyzer according to the present invention, and correspond to the microscope objective 12, lenses 14, 16 20, 24, volume Bragg grating 22 and photodetector 26 of the embodiment of FIG. 2. However, the diagram of FIG. 5 provides a more general understanding of the functional aspects of the system that go beyond the specific embodiment of FIG. 2. Since the specific directional components of the wavevectors are preserved during the filtering, the intensities detected at the photodetector 54 are correlated to the individual wavevectors of the EM signal from the structure 28, allowing a full characterization of the material as discussed above.

In another embodiment of the invention, the filter 52 of FIG. 5 is a multiband filter arrangement, which may take a variety of different forms. In one version of this embodiment, the electromagnetic signal is separated into multiple beams using one or more beam splitters, dichroic mirrors, reflection Bragg gratings or the like. Each of these beams is then treated independently. For example, the beams may each be projected directly onto a photodetector, or a different region of the same photodetector. Alternatively, each of the separated beams could be passed through a separate tunable filter before being directed to a photodetector (or photodetector region). If a relatively low number of energies are of interest, these tunable filters could be replaced by fixed energy filters. Those skilled in the art will understand that a multispectral embodiment of the invention may take any of these forms, or may even be some other combination of fixed and tunable filters.

Although the EM energy from an SPR surface has been used as an illustrative example herein, the present invention is not limited to the field of surface plasmons. Indeed, there are numerous other fields to which the invention may be applied. The present invention allows the hyperspectral filtering of electromagnetic energy in a manner that retains the directional information of the signal while allowing the analysis of the individual energy characteristics. Such a system may be used, for example for analyzing the directional variations in the intensity of light at different energies from a light source or a plurality of light sources, such as an LED array. Other advantageous uses might include the inspection of crystals, the inspection of lenses or mirrors, the inspection of paint on surfaces for defect detection or the inspection of metals for surface defect detection. These and other possible applications of the invention are likewise anticipated.

1. An apparatus for characterizing energy and direction dependence of intensity for an electromagnetic signal, the apparatus comprising:
an energy dependent filter located in an imaging space of the signal, the filter being capable of separating the signal in an energy dependent manner to provide a plurality of different predetermined energy band ranges such that, for each of said energy band ranges, a different signal portion is directed to an output location; and
at least one photodetector that receives the different signal portions and detects signal intensities at a plurality of locations within a cross section of a received signal portion, each of said locations corresponding to a specific direction and energy band within the predetermined energy band range of the received signal portion.

2. An apparatus according to claim 1 wherein the electromagnetic signal originates as divergent electromagnetic energy from an object, and collection optics are used to collect and focus the electromagnetic signal.

3. An apparatus according to claim 2 wherein the collection optics comprise a microscope objective.

4. An apparatus according to claim 2 wherein the collection optics comprise an optical element that focuses the electromagnetic signal.

5. An apparatus according to claim 4 wherein the focusing element comprises a lens.

6. An apparatus according to claim 4 wherein the focusing element comprises a mirror.

7. An apparatus according to claim 1 wherein the energy dependent filter is tunable.

8. An apparatus according to claim 1 wherein the energy dependent filter comprises a volume Bragg grating.

9. An apparatus according to claim 1 wherein the energy dependent filter is located substantially at a focal plane of the electromagnetic signal.

10. An apparatus according to claim 1 wherein the photodetector is located substantially at a pupil plane of the electromagnetic signal.

11. An apparatus according to claim 1 wherein the photodetector comprises a two-dimensional photodetector array.

12. An apparatus according to claim 1 wherein the electromagnetic signal is received from a surface as a result of a surface plasmon resonance event.

13. An apparatus for characterizing the electromagnetic energy emissions from a surface at which a surface plasmon resonance event takes place, the apparatus comprising:
collection optics that collect and focus the electromagnetic signal;
a volume Bragg grating located in a focal plane of the signal, the grating separating the signal in an energy dependent manner such that a first portion of a signal output from the grating is directed to an output location and is limited to a predetermined range of narrow energy bands, the filter being tunable so as to change the predetermined energy band range; and
a two-dimensional photodetector array located at the output location that receives the first signal portion and detects signal intensities at a plurality of locations within a cross section of the first signal portion, each of the signal intensities corresponding to a specific direction and energy band within the predetermined range.

14. A method for characterizing energy and direction dependence of intensity for an electromagnetic signal, the method comprising:
locating an energy dependent filter in an imaging space of the signal, the filter being capable of separating the signal in an energy dependent manner to provide a plurality of different predetermined energy band ranges; and
for each of the predetermined energy band ranges, directing a signal portion corresponding to that energy band range to a photodetector that detects signal intensities at a plurality of locations within a cross section of that signal portion, each of said locations corresponding to a specific direction and energy band within the predetermined range.

15. A method according to claim 14 wherein the electromagnetic signal originates as divergent electromagnetic energy from an object, and wherein the method further comprises using collection optics to collect and focus the electromagnetic signal.

16. A method according to claim 15 wherein the collection optics comprise a microscope objective.

17. A method according to claim 15 wherein the collection optics comprise an optical element that focuses the electromagnetic signal.

18. A method according to claim 17 wherein the focusing element comprises a lens.

19. A method according to claim 17 wherein the focusing element comprises a mirror.

20. A method according to claim 14 wherein the energy dependent filter is tunable.

21. A method according to claim 14 wherein locating an energy dependent filter in an imaging space of the signal comprises locating a volume Bragg grating in said imaging space.

22. A method according to claim 14 wherein locating an energy dependent filter in an imaging space of the signal comprises locating the energy dependent filter substantially at a focal plane of the electromagnetic signal.

23. A method according to claim 14 wherein receiving the first signal portion with a photodetector located at the output location comprises receiving the first signal with a photodetector located substantially at a pupil plane of the electromagnetic signal.

24. A method according to claim 14 wherein the photodetector comprises a two-dimensional photodetector array.

25. A method according to claim 14 wherein the electromagnetic signal from an object is influenced by a surface plasmon resonance event.
